(19) United States
(12) Patent Application Publication
(10) Pub. No.: US 2019/0138923 A1
(43) Pub. Date: May 9, 2019

(54) SYSTEM AND METHOD FOR OBTAINING AND TRANSFORMING INTERACTIVE NARRATIVE INFORMATION

(71) Applicant: Andrea Gibb JACOBS, Arlington, VA (US)

(72) Inventor: Andrea Gibb JACOBS, Arlington, VA (US)

(21) Appl. No.: 16/180,807

(22) Filed: Nov. 5, 2018

Related U.S. Application Data
(60) Provisional application No. 62/581,445, filed on Nov. 3, 2017.

(51) Int. Cl. G06N 5/04; G06F 17/30; G06N 99/00; G06F 17/27

(52) U.S. Cl. CPC G06N 5/046; G06F 17/2785; G06N 99/005; G06F 17/30312

(57) ABSTRACT

A system and method for obtaining and transforming interactive narrative data comprise a creation space configured to present a predetermined narrative structure and configured to obtain narrative responses from at least one individual, with the narrative responses are discretized according to story acts. A custom ontology is developed for applying sentiment analysis to each of the discretized story acts with a qualitative and quantitative emotional value applied to each, and a processor determines a story arc corresponding to the emotional values, with an emotional profile developed for the individual based on the story arc.

### CROSS-REFERENCE TO RELATED APPLICATIONS

This application claims priority to U.S. Provisional Application No. 62/581,445, filed on Nov. 3, 2017 which is incorporated herein by reference.

### FIELD OF INVENTION

The present disclosure relates to a system and method for obtaining and transforming interactive narrative information from at least one individual by obtaining the narrative information in a creation space and transforming the narrative information in an artificial intelligence emotion engine.

### BACKGROUND

While individuals long for meaningful connection with other people, technology that facilitates connection is generally surface level, leaving many people feeling isolated, as the connections formed by text messaging, instant messaging, and social media do not create genuine relationships. Indeed, numerous studies tie social media usage to feelings of loneliness, with many psychologists and organizations attempting to help people navigate their way through social media and loneliness. The rise of shallow online experiences, comprising for example the simple elicitation of “likes,” “shares,” and emojis, is reflected in modern declines in personal well-being.

Streaming and new digital technologies has not helped. While new feeds on Spotify, iTunes, Twitter, and Instagram offer new ways for a person or entity to link with other people and learn about trends, markets, and news, such platforms are not developed to generate meaningful connection or to promote self-actualization of the individuals.

The music industry is exemplary of this problem. Artists remain largely incapable of having direct and meaningful relationships with fans, the very group the artists want to reach, by whom their work is funded, and for whom their work is created. The connection between artist and fan is broken. The music industry, which takes the bulk of the revenue generated by the most popular artists, does not foster direct connection between the artist and the fan. As a result, recorded music has been devalued.

Entertainers, artists, politicians and candidates, and other entities who create content for a particular audience are then faced with a difficult dilemma: how to interact with and meet the needs of their audience when there is limited non-narrative audience feedback. The ability to receive valuable feedback from an audience has not improved significantly since the pre-digital broadcast age, when radio and television programs were delivered in one-way transmissions. The current state of storytelling remains limited to one-way communication and does not provide people with meaningful opportunities to connect with each other through personally meaningful narratives.

Even when audience feedback is available, it is often minimal and fails to help a creator connect meaningfully with an audience. Most ratings for television programs are determined solely on select households with at least one person estimated to watch the program during a specified time. Movie reviews such as Rotten Tomatoes base a score for a movie on a one-dimensional critic rating, such as a scale from one to five stars. Music is frequently judged for example by its position on Billboard's Top 40 list, which is based primarily on airplay and sales. Approval ratings for politicians ask individuals a simple yes or no question: “Do you approve of the politician's job so far?” While such metrics can provide basic answers as to the number of people in an audience or whether people like something generally, it offers minimal insights.

Existing modalities of communication and interpersonal connection lack an interactive way to engage with individuals to ascertain the reasons that individuals respond positively to certain content or programs compared to other content. Networks still cannot reliably pinpoint and replicate how the most successful television shows of all time (M*A*S*H, Seinfeld, The Sopranos, I Love Lucy) earned such large, loyal, and long-term audience followings. Movie studios similarly cannot understand why fans identify with some movies and not with others. The same can be said for musicians, politicians, authors, therapists, consultants, and many others. Without insights regarding people's thoughtful, narrative responses, which indicate their emotional motivations, there is a lack of reliable means to develop, strengthen, and personally relate narratives directly to individuals and/or organizations.

Existing attempts to create a more meaningful connection between individuals fall short of extracting, processing, and making sense of data in a meaningful way. Some entities attempt to trawl data from shallow sources, such as social media, to tease out deeper trends and meanings. Others provide guidelines that purportedly help a creator to more meaningfully address their audience, by coaching an artist on how to think about the cultural contexts of their audience. Yet others provide plug-in apps for a website to streamline revenue generation from an audience. There is a failure among current means to create more meaningful interactions to address the fundamental problem of a lack of effective two-way conversation and storytelling that facilitates genuine human connection.

Efforts have been made to analyze classical literature using artificial intelligence to ascertain deeper meanings such as narrative information, but such efforts have been directed to works of fiction or to trawling social media sites including Twitter to gather information about people. However, such sources of information are bereft of context and offer only shallow data to analyze. It is admitted in these circles that the dearth of context in data is a problem for which there is not a straightforward solution.

Creating meaningful connections between people of like minds and analogous life experiences is not possible using existing technologies and methods. There is a problem of existing technologies, professionals, and support groups being unable to accurately connect people to each other based on common interests, experiences, motivations, and life narratives. There is a need for a system and method for eliciting richer narrative data than individuals have been conditioned by digital means to provide.

There is further a problem of adequately providing an interactive storytelling platform in a digital space. Creators may consult in person with an individual regarding the individual's personal attachment to or engagement with a particular creation, such as a movie, thereby obtaining feedback that can be more multi-dimensional than a simple rating can convey. For instance, the individual may indicate that a particular character resonated with the individual because of a particular memory or event in the individual's past. However, the creator's reception of and reaction to this feedback is inherently subjective, and a human creator cannot objectively and quantitatively survey the potentially millions of individuals in their audience and adapt their work thereto, let alone tailor their creation to each of the potentially multitudinous individuals in the audience and based on related personal narratives.

The creator's reception of feedback occurs after a finished creation has been presented to the audience, as opposed to receiving iterative feedback during the creation process. Optimal storytelling requires that the storyteller (e.g. a creator) shares little information and then listens for feedback from their audience before continuing with the story, enabling the storyteller to tailor the story to the needs of the audience as perceived from the received feedback. This is especially critical when dealing with a large, diverse, and/or remote audience or constituency. But the current model of audience engagement precludes a creator from tailoring their material or message based on early and/or iterative audience feedback which is objectively processed and quantified. There is a need for a digital system that can provide for iterative objective feedback between a creator and an audience during the creation process.

No digital creation space exists for meaningful narrative reflection and iterative collaboration between people, and people are thus conditioned for only shallow, surface-level engagement (the level of engagement provided by social media and to which most individuals and audiences are accustomed), as opposed to meaningful narrative engagement with another person. One reason is that such narrative engagement is usually perceived as taking too much time. A brand may note the number of “likes” and “loves” that a certain sponsored post generates on its Facebook page, or even of certain comments left thereon. But there is no purpose-built creation space that allows for the brand to not only solicit thoughtful narrative responses from its audience or other individuals but also to thereafter analyze the responses in an objective, quantitative manner and that transforms the narrative responsive data into novel narrative insights about a group or individual. There is accordingly a need for a digital collaboration system and method that guides individuals and audiences into a deeper, more meaningful narrative conversation.

In view of the foregoing, there is a need for an integrated system and method for soliciting deeper, richer narrative data from a person, processing and storing the data as a narrative, and generating emotional profiles of an audience that allows people to co-create a meaningful narrative or product.

### SUMMARY

The problem of interaction between people being limited to shallow one-way or one-dimensional communication and the difficulty of obtaining personally meaningful information is solved in the present disclosure by providing a system and method for obtaining and transforming interactive narrative information. The method may comprise the steps of providing a creation space including at least one predetermined narrative structure, obtaining narrative data from at least one individual through the digital platform and based on the narrative structure, processing and storing the narrative data as a linear narrative, developing an emotional profile of the individual based on predetermined qualitative variables identified in the obtained narrative data, extracting and processing data sets from the obtained narrative data according to the identified predetermined variables, and providing output data according to the processed data sets.

Narrative data representing a deeper and more meaningful reflection of an individual individual's personality, motivations, and preferences may be obtained in a first stage of the method and system by providing a purpose-built creation space, including a digital creation space. The creation space provides an interactive framework where predetermined narrative structures may be presented for an individual's viewing, listening, or other mode of consumption. Predetermined stepwise inquiries are then presented to the individual, gradually eliciting a greater depth of interactive narrative responsive data to the predetermined narrative structure while re-conditioning the individual for meaningful narrative engagement.

In contrast to standard databasing techniques which break data sets into discrete non-linear objects divided within relations by attributes, and thereby do not capture or store narrative context, the obtained narrative responsive data is compiled as a linear and progressive narrative data set and stored in a database with its narrative context intact (i.e. not divided by attribute into discrete fields), each narrative data set typically representing at least one life event elicited in response to the at least one predetermined narrative structure. Because standard databasing techniques focus on sequeling and processing speed rather than on the retention of narrative context, the arrangement of narrative data sets as undivided linear data sets according to embodiments of the disclosure is not readily apparent to one skilled in the art.

To process and transform the linear narrative data obtained from re-conditioning individuals and audiences using predetermined narratives in the creation space, a processor cooperating with or comprising an emotion engine is provided to analyze and transform the obtained richer narrative data within the narrative data sets. The emotion engine provides objective analysis and valuation of the obtained richer narrative data by providing semantic analysis, sentiment analysis, and, when appropriate, visual analysis of the obtained narrative data using natural language processing, machine learning, a combination of the foregoing, or other suitable artificial intelligence tools. In so doing, the emotion engine assigns positive or negative cues in the form of a qualitative emotional value assigned to discrete portions of an individual narrative data set. A story pattern can be ascertained from a sequence of emotional values assigned to the discrete elements of the narrative data, which is used to develop an emotional profile for a respondent.

For example, the emotion engine may cooperate with the creation space to discretize the interactive narrative responses provided and received in the creation space into predetermined categories or “acts” of a storytelling pattern or story arc and assigns emotional values or tags to each of the acts within the interactive narrative response based on semantic analysis performed on each act. While it is known that there are five basic acts of a complete story arc (in sequential order: exposition, rise, climax, fall, and resolution), it is not readily apparent to skilled persons how to obtain such narrative information as is done in the creation space of embodiments of the present disclosure, or how to retain the narrative information pertaining to these acts in an order that reveals story arcs representing an individual's meaningful life events.

When the emotion engine assigns emotional tags to acts of a story arc within obtained interactive narrative data, a particular story arc may be ascertained based on the progression of the emotional tags in subsequent acts. This is based on the qualitative emotional tag that is assigned at each of the acts, as well as a quantitative value that may be predetermined for the qualitative emotional tag. For instance, the emotional tag “happy” may have a positive value, while “abandonment” may have a negative value. A story arc known as “riches to rags” may be assigned to the narrative data set based on a pattern exposition (+), rise (+), climax (−), fall (−), resolution (−), indicating that the exposition and rise were assigned positive-value emotional tags, while the climax, fall, and resolution were assigned negative-value emotional tags.

There are generally six types of story patterns or arcs: “rags to riches,” entailing a steady rise from bad to good fortune; “riches to rags,” entailing a fall from good fortune to bad fortune, or a tragedy; “Icarus,” entailing a rise then a fall in fortune; “Oedipus,” entailing a fall, a rise, then a fall again; “Cinderella,” entailing a rise, then a fall, then a rise; and “Man in a hole,” entailing a fall then a rise. Some have attempted to ascertain a story arc of classical pieces of fictional literature by applying semantic analysis, but skilled persons have not ascertained a way to apply this knowledge of story arc patterns and semantic analysis techniques to the problem of obtaining and transforming interactive narrative data from individuals and communities. The five story acts and six types of story arcs are exemplary and are not intended to limit the number or type of story acts and story arcs of the disclosure.

Embodiments of the present disclosure advantageously bridge this gap by providing the creation space which is arranged to re-condition individuals for narrative engagement with a predetermined parabolic narrative structure (which follows one of the above-mentioned six story patterns) and to thereby obtain interactive narrative data corresponding to one or more of the five acts of a story which story follows and patterns after the arc of the predetermined narrative structure. The obtained interactive narrative data is then processed and transformed by the emotion engine to assign emotional tags and values to each of the story acts and thereby assess a story pattern from the obtained narrative data corresponding to the profile of the emotional tags.

For instance, a particular individual's narrative response to a predetermined narrative structure may be determined in the emotion engine based on semantic and sentiment analysis to progress as follows: exposition (−), rise (−), climax (+), fall (+), resolution (+), with negative emotional values assigned at the exposition and rise, and positive emotional values assigned at the climax, fall, and resolution. After cross-referencing a cumulative value provided by the individual against a cumulative value generated by the emotion engine to ensure accuracy, the emotion engine can assign a particular story arc fitting the narrative response, such as “rags to riches.”

The data thus analyzed and transformed in the emotion engine can be used to establish an emotional profile for a particular individual, with the emotional profile indicating a range of specific emotional tags and values associated with the predetermined narrative structure.

The emotion engine builds and utilizes a custom ontology in response to the obtained narrative data. The custom ontology comprises an evolving set of rules and patterns that establish a normalizing procedure for conducting semantic and sentiment analysis on narrative data obtained from different individuals. For instance, the emotion engine including a natural language processor, machine learning model, a combination thereof, or other suitable artificial intelligence tool may assess that a particular combination of words and/or idiomatic expressions correlates to abandonment issues. This assessment of ontology is enhanced by the context provided by the narratives obtained in the creation space. The custom ontology is built cumulatively as more individuals' narrative responsive data are provided, with the custom ontology applied universally, minimizing subjectivity inherent to human analysis while increasing accuracy of the assessments.

Surprisingly, it has been found that when human data analysts attempt to assign emotional tags and values to a shared set of data, the human data analysts agree upon and select the same emotional values when analyzing tweets about a known topic of conversation only about 65% of the time, owing to the subjectivity of human analysis of different words and language patterns.

It has been advantageously found, however, that by using the system and method for obtaining and transforming interactive narrative data, the subjectivity of human analysis may be replaced by objective sentiment analysis based on the custom ontology developed in the emotion engine, with the resulting emotional profiles demonstrating that the same story pattern consistently emerges from individuals in response to a particular predetermined narrative structure, even when human analysts detect divergence in the emotional values of the responses.

This occurs because the creation space of embodiments of the disclosure has been found to successfully instigate a phenomenon of brain activity known as “parallel processing” in individuals, such that the individuals consistently provide narrative corresponding to and having a similar story arc as the predetermined narrative structure. Indeed, this consistency of responses becomes more pronounced when the narratives are transformed through the emotion engine as discussed in further detail herein.

In parallel processing, the individual's brain syncs with the narrative structure being presented, producing analogous storylines derived from the individual's life experiences that follow a similar story arc; for example, an individual may be reminded of a time when they experienced an Oedipus-type series of events as they view a story that follows an Oedipus arc. In a safe space such as the creation space of embodiments of the disclosure, an individual may thus be exposed to one or more of a selection of predetermined narrative structures corresponding to the above-mentioned story arcs, inviting and re-conditioning the individual to provide narrative details from their own life experiences corresponding to the presented narrative structure. In this way, corresponding narrative patterns are thereby reliably obtained in the creation space and transformed in the emotion engine, with the custom ontology arranged to provide objective analysis of the obtained narrative data.

A listening engine is further provided to further transform the obtained narrative data based on established emotional profiles. When more than one individual provides interactive narrative data in the creation space, the emotion engine may provide transformative analysis for each of the resulting obtained narrative data sets and may ascertain a story pattern from each, with a corresponding emotional profile developed for each. Intertwined storylines are developed in the listening engine as corresponding emotional values or tags are identified in corresponding acts of corresponding story arcs, revealing a response pattern across multiple individuals. As intertwined storylines are built from the obtained narrative data, a community profile may be developed for the audience as a whole. The emotional profiles and community profiles may be segmented by core emotional drivers and values as generated by the emotion engine.

The creation space of embodiments of the present disclosure solves the problem of a lack of digital creation spaces that facilitate thoughtful, narrative dialogues between people. The digital creation space is built on a storytelling framework encouraging reflection, shared narrative and experience, and positive feedback between people. By providing a digital creation space according to the present disclosure, creators can iteratively create while receiving narrative feedback throughout the creation process from their target audience, and non-intuitive connections can be developed between people who may have corresponding narrative experiences, all while being re-conditioned for deep narrative engagement.

The exemplary embodiments of the system and method for obtaining and transforming interactive narrative data further enable a much deeper comprehension of people by generating a context-specific profile of the narratives, experiences, and values that most resonate with people. The problem of marketers, entertainers, politicians, therapists, and others incorrectly extrapolating from and acting upon limited, shallow data about individuals is thus addressed by providing a narrative context-specific emotional profile that more accurately and efficiently guides and informs transformative analysis about the individuals, facilitating deeper connections between individuals.

These and other features of the disclosure will become better understand regarding the following description, appended claims, and accompanying drawings.

### BRIEF DESCRIPTION OF THE DRAWINGS

FIG. 1 depicts a flowchart showing the method for obtaining and transforming interactive narrative information.

FIG. 2 depicts a creation space according to the present disclosure.

FIG. 3A depicts a predetermined narrative structure as presented within the creation space of FIG. 2.

FIG. 3B depicts a predetermined stepwise inquiry as presented within the creation space of FIG. 2.

FIG. 3C depicts another predetermined stepwise inquiry as presented within the creation space of FIG. 2.

FIG. 3D depicts another predetermined stepwise inquiry as presented within the creation space of FIG. 2.

FIG. 3E depicts another predetermined stepwise inquiry as presented within the creation space of FIG. 2.

FIG. 3F depicts another predetermined stepwise inquiry as presented within the creation space of FIG. 2.

FIG. 3G depicts another predetermined stepwise inquiry as presented within the creation space of FIG. 2.

FIG. 3H depicts another predetermined stepwise inquiry as presented within the creation space of FIG. 2.

FIG. 4A depicts another embodiment of a predetermined stepwise inquiry as presented within the creation space of FIG. 2.

FIG. 4B depicts another predetermined stepwise inquiry.

FIG. 4C depicts another predetermined stepwise inquiry.

FIG. 5 depicts the emotion engine according to embodiments.

FIG. 6A depicts a discretized linear narrative data set obtained in the creation space according to embodiments.

FIG. 6B depicts a tabular output from the emotion engine of FIG. 5 corresponding to three discrete series of narrative responses from an individual.

FIG. 6C depicts a sample tabular output from the emotion engine of FIG. 5 corresponding to three discrete series of narrative responses from an individual.

FIG. 7 depicts a listening engine according to embodiments.

FIG. 8A depicts a graphical output from the emotion engine of FIG. 5 corresponding to a rags to riches story arc.

FIG. 8B depicts a graphical output from the emotion engine of FIG. 5 corresponding to a man in the hole story arc.

FIG. 8C depicts a graphical output from the emotion engine of FIG. 5 corresponding to a riches to rags story arc.

FIG. 8D depicts a graphical output from the emotion engine of FIG. 5 corresponding to an Oedipus story arc.

FIG. 8E depicts a graphical output from the emotion engine of FIG. 5 corresponding to an Icarus story arc.

FIG. 8F depicts a graphical output from the emotion engine of FIG. 5 corresponding to a Cinderella story arc.

FIG. 9 depicts an abstract view of a computer system on which embodiments of the system and method for obtaining and transforming interactive narrative information may be housed and performed.

The drawing figures are not necessarily drawn to scale, but instead are drawn to provide a better understanding of the components, and are not intended to be limiting in scope, but to provide exemplary illustrations. The figures illustrate exemplary configurations of a system and method for obtaining and transforming interactive narrative data, and in no way limit the structures, configurations, or methods of a system and method for interactive two-way communication according to the present disclosure.

### DETAILED DESCRIPTION OF VARIOUS EMBODIMENTS

The embodiments of a system and method obtaining and transforming interactive narrative data address the problems of shallow data yielding inaccurate, untimely information about individuals, and enable the collection of richer narrative information from an individual with objective transformational analysis performed thereon.

The embodiments may be implemented to overcome many of the technical difficulties and computational expenses associated with obtaining and transforming narrative data about individuals. The embodiments provide a combined order of specified rules that render interactive narrative information into a specific format used to create emotional and community profiles in an objective, quantitative way that overcomes the limitations of current analog methods for assessing narrative meaning, especially across multiple individuals and individual narrative responses. By providing the system and method for obtaining and transforming interactive narrative information according to the embodiments, a custom ontology defining rules and procedures for quantitatively interpreting sentiment and other narrative data may be universally applied to multiple individuals, thereby providing improved results that mitigate human subjectivity.

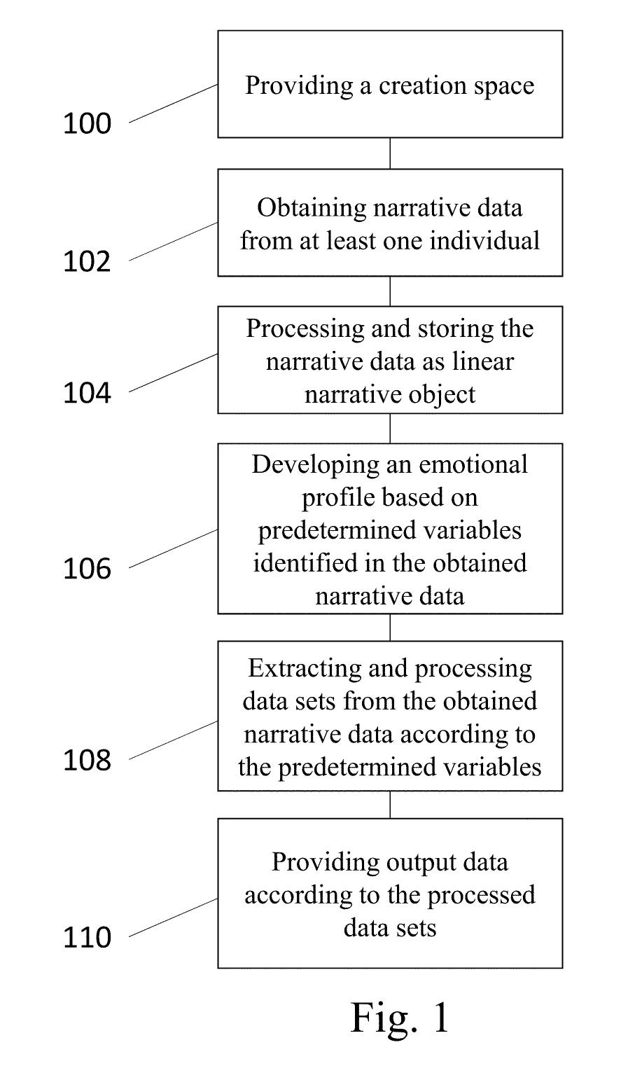

In the flowchart depicted in FIG. 1, an embodiment of a method for eliciting interactive narrative data from individuals and performing transformational analysis thereon is provided by providing at step 100 a creation space that is purpose-built for presenting a predetermined narrative structure and eliciting narrative responses thereto. In embodiments, the creation space 100 may be defined as a digital creation space embedded in an intuitive website or in a mobile app. The predetermined narrative structure may be arranged as a video, a musical composition, a slide presentation, a multimedia presentation, an article, a spoken narrative recitation, or any other medium that may convey narrative information.

The predetermined narrative structure may further be selected to evoke a narrative response from a viewer, such that the viewer is encouraged to contemplate on an emotionally meaningful life event through parallel processing. In embodiments, the predetermined narrative structure corresponds to one of the six story arcs mentioned above, and follows one of a rags to riches, riches to rags, Icarus, Oedipus, Cinderella, or Man in a hole story arc.

At step 102, the digital creation space is arranged to obtain narrative data from the at least one individual by providing, for example, a series of gamified prompts and inquiries that progress in stepwise fashion into more meaningful narrative responses that convey a linear narrative pertaining to, for example, an emotionally meaningful life event patterned after the predetermined narrative structure. It has been found that due to the shallow engagement promulgated by social media technologies since the early 2000s, individuals are conditioned to provide only surface-level reactions, such as emoji responses or “likes,” to presented material. If asked immediately to provide deep narrative information in response to a predetermined narrative structure, whether digitally or in person, individuals are unlikely to provide a meaningful response or to respond at all. The conditioning of shallow social media engagement thus makes obtaining narrative information a tremendous challenge.

Advantageously, it has been found that providing a stepwise progressing series of gamified predetermined prompts and inquiries that increasingly evoke narrative responses relating to the predetermined narrative structure can re-condition an individual toward meaningful engagement, especially digitally. Thus at step 102 the series of gamified prompts and inquiries are arranged to obtain narrative information from the individual as the individual participates in the digital creation space. As regards “gamified” inquiries, a person having skill in the art of gamification will understand that the techniques particular to gamification and narrative structure may be adapted or in particular reversed to design inquiries pertaining to a story arc that lead an individual to describe step-by-step an analogous story arc crafted from their own meaningful life experiences. For instance, when an individual is asked to identify a scene or a character they most identify with, they may be gently eased into a narrative journey or path that ultimately completes a narrative.

In an exemplary embodiment, the predetermined narrative structure provided in the digital creation space is arranged to remind an individual of a meaningful life experience relating to a predetermined emotional value and to re-condition the individual into narrative engagement. A series of stepwise progressing inquiries are presented to the individual immediately after viewing the predetermined narrative structure. A first inquiry of the series of inquiries may ask, for example, a multiple-choice question regarding discrete and/or memorable instances or scenes from the predetermined narrative structure that stood out to the individual, this constituting a simple response that requires the individual to begin to think about and relate the predetermined narrative structure to a meaningful life experience, but without immediately asking for a narrative response from the individual. In this way trust is established and developed early in the inquiry process to gradually encourage and re-condition the individual to open up, explore personal narratives elicited during parallel processing, and then share the personal narratives.

Next the individual may be asked to produce an increasingly narrative response, by suggesting, for example, an appropriate title, explanation, or description of the discrete and/or memorable instances identified in the first question, this encouraging the individual to provide a personal narrative response that corresponds to the predetermined narrative structure. This may indicate a shared value gleaned from the predetermined narrative structure and the individual's own life experience, such as the importance of loyalty, compassion, fairness, joy, family, or otherwise.

In further inquiries, the individual may be asked to describe the reasons that they chose their answer to the second inquiry; in particular, the individual may be prompted to explain why they found a particular title, explanation, or description of the discrete and/or memorable instances identified in the first inquiry to be appropriate. The individual's response further elucidates narrative reasons or emotional values that, when interpreted in the context of the predetermined narrative structure, provide deeper and more objective narrative data than can be obtained from polls, social media responses, or focus groups. The second inquiry serves to further re-condition the individual into gradually engaging and sharing more narrative information.

In yet further inquiries, the individual may be prompted, after being properly primed and reconditioned by the preceding inquiries for deeper narrative engagement with the predetermined narrative structure, to share or describe a meaningful event from their own life representing a correlating narrative pattern via video, image, audio recording, text, or other medium. This may be done in a series of discrete inquiries requiring discrete responses and corresponding to one or more of the five acts of a story.

In a final inquiry or step, the individual may be prompted to select from a list of available emotional tags the particular values or emotions that they associate with the predetermined narrative structure in view of the responses elicited by the preceding questions and inquiries, which have led the individual to develop a personal narrative response to the predetermined narrative structure. The final value or values selected by the individual may, among other uses, be compared against a narrative or storylines analysis performed in later steps described herein to check for accuracy of the semantic and sentiment analysis performed on the narrative data.

In any of the preceding inquiries, the inquiries may be arranged to elicit at least one narrative response corresponding to at least one of the acts of a story arc. In embodiments, narrative responses directed to each of the five acts of a story arc are elicited in subsequent inquiries. Any arrangement or particular acts of a story arc may be included or excluded from the inquiries provided in the creation space.

In embodiments, the creation space may not be digital, but may rather be performed in a group setting, in an individual setting between two people, or in other formats.

At step 104, the obtained narrative data from individuals is processed and stored in a database within memory or storage by a processor as linear narrative data, retaining the contextual information. Whereas most databases store individuals data objects by separating attributes in discrete tables that are re-assembled later via sequeling statements, for example, the database of the embodiment stores each of the data objects obtained from step 102 in the order and context it was received rather than discretizing the attributes or objects, thus retaining the narrative details that provide context and allow for a processor to attach emotional values at discrete portions of the narrative data.

Standard databasing techniques assume that data will be broken up and stored as data points in discrete groups pertaining to individual attributes for the sake of speed when a sequeling operation is performed. By contrast, the data of the present disclosure obtained in the creation space is stored in a database in a way that retains the obtained data in the order it was received and with the predetermined narrative structure to which it corresponds, thereby retaining the obtained information in the narrative context that elicited it. In embodiments, the narrative data obtained in step 102 may alternatively be obtained from or supplemented by traditional sources of information such as social media posts.

By storing the data obtained at step 102 as a linear narrative rather than discretizing the data objects based on attribute as is done in conventional database systems in use today (the discretization aiming to improve efficiency of sequeling processes), an emotion engine embedded in a processor is able to transform the obtained linear narrative data into emotional profiles in step 106 and later weave the narrative structure together with corresponding narrative data sets based on emotional values identified in the narrative data. In an embodiment, the obtained narrative data pertaining to each individual of an audience is analyzed by the emotion engine using systematic learning, including semantic analysis techniques, such as sentiment analysis performed on an individual's written responses using a natural language processing device, a machine learning model, a combination of the foregoing, or other suitable artificial intelligence tool. Visual analysis may be likewise performed on images or videos uploaded by an individual.

The emotion engine comprises and continuously builds a custom ontology defining sets of rules and relationships that may be applied and developed universally and objectively. In embodiments, the emotion engine comprises a machine learning model that develops relationships between combinations of words and expressions assessed during the natural language processing, said relationships corresponding to qualitative emotional values. In an embodiment, the custom ontology may determine that the use of “anxious,” “alone,” or equivalents thereof may correspond to the emotional value or concept of “abandonment.” The machine learning and semantic learning procedures employed by the emotion engine are described in greater detail hereafter.

After the obtained narrative data is stored as linear narrative objects in the database, the emotion engine may determine a predetermined variable such as a qualitative emotional value for each narrative response within the linear narrative object based on the semantic analysis performed on the responses contained in the linear narrative object. The value may be defined along a quantitative spectrum established in the custom ontology, from negative values up to positive values. For instance, a highly negative emotional value such as “hate” or “shame” may have a lower quantitative value than “disappointment,” which in turn has a lower quantitative value than “appreciation.” This process advantageously applies a uniform and objective method to evaluate emotional patterns within a plurality of narrative data objects, immune to the subjectivity of a human analysis of the narrative data objects.

In an embodiment, a negative value may influence a degree to which the semantic analysis indicates that an individual reacted with primarily negative or undesirable emotional values (e.g. sadness, regret, anger, abandonment, shame) and a positive value may by contrast influence a degree to which the semantic analysis indicates a primarily positive reaction (e.g. happiness, joy, fond memories). In other embodiments, the positive or negative values may measure a degree of engagement or relation to the predetermined narrative structure as indicated by the individual's responses. The narrative data obtained in the creation space and the semantic valuations thereof may be transformed, due to the narrative order in which the narrative data is obtained in the creation space, into a story arc and associated cumulative emotional value. Emotional values may be identified as a cumulative value for the narrative and/or throughout the linear narrative object, and multiple emotional values may be assigned by the processor at a discrete data point.

The determined values at discrete points in the linear narrative object may be used to ascertain a cumulative story pattern and/or cumulative value, which may be cross-referenced in certain embodiments against an individual-provided value or values representing a cumulative emotional value. This step advantageously increases accuracy of the analysis by ensuring alignment with the individual's intended response. An individual may be prompted to provide or select an emotional value they consider to describe each discrete portion or act of the narrative response. Additionally, clarifying questions may be presented to the individual to ensure accurate representation of the individual's emotional response.

In embodiments, if the emotion engine-generated cumulative value and the individual-provided emotional value do not align, the information may be assessed by a data specialist for accuracy. In other embodiments, the assigned emotional values are supplemented by a data specialist or narrative analyst, who may add an additional layer of emotional values and/or may adjust the assigned emotional values as deemed necessary. The data specialist or narrative analyst advantageously adds an additional layer of accuracy to the emotion engine.

The development of an emotional profile in step 106 comprises developing an emotional depiction or profile of an individual based on the assigned emotional values in the linear narrative objects. For instance, a predetermined narrative structure may elicit narrative responses within which are identified as various predetermined variables such as emotional tags and values. A cumulative story assessment may be provided with an emotional value tied to a story arc, for example a fear-driven riches to rags story.

At step 108, the emotional profile is used to extract narrative data. For example, in an embodiment the predetermined narrative structure may be a draft of a motion picture featuring a superhero character first developed in comic books and engaged in one of the six above-mentioned story arcs, and a creator or movie studio may be interested in ascertaining a potential theater-going audience's emotional response to the story arc. A data set developed at step 110 from the emotional profile generated from the interactive narrative objects in a creation space may indicate at step 112 that, as an example, a potential theater-goer would respond positively to a character exhibiting a particular emotional value, such as loyalty, this emotional value being objectively ascertained by the big data engine at steps 106 and 108.

In other embodiments, the data set developed at step 110 may indicate that a particular individual, based on the narrative data provided and processed in the method 100, would relate positively to and benefit from interacting with a second particular individual based on the second individual's processed narrative data. In exemplary embodiments, a separate data set is provided at step 110 for each category of emotional values identified in steps 106 and 110. One of skill in the art will understand that the data set developed at step 110 may comprise any format that communicates the data received at step 102, processed at step 104, and developed into an emotional profile in step 106.

The method 100 described above may be utilized in a listening engine provided according to the present disclosure. The listening engine is configured to receive the emotional profile developed at step 106 based on obtained narrative data from an individual and to facilitate connections between individual individuals, and between a creator and an audience of individuals, according thereto. A creator using the listening engine is enabled to intelligently design stories around the personal experiences of its fan base and prospective fans, tap into the emotional drivers of its audience members and create stories based on what motivates its audience, and meaningfully interact with its fan base or constituency by obtaining and transforming interactive narrative data.

Intertwined storylines are generated in the emotion engine and listening engine by the processor across a plurality of linear narrative objects based on common patterns identified therein; for example, the processor may identify a common thread of a particular emotional value or assigned quantity of an emotional value evoked at a particular inquiry across a plurality of linear narrative objects, as described in greater detail herein.

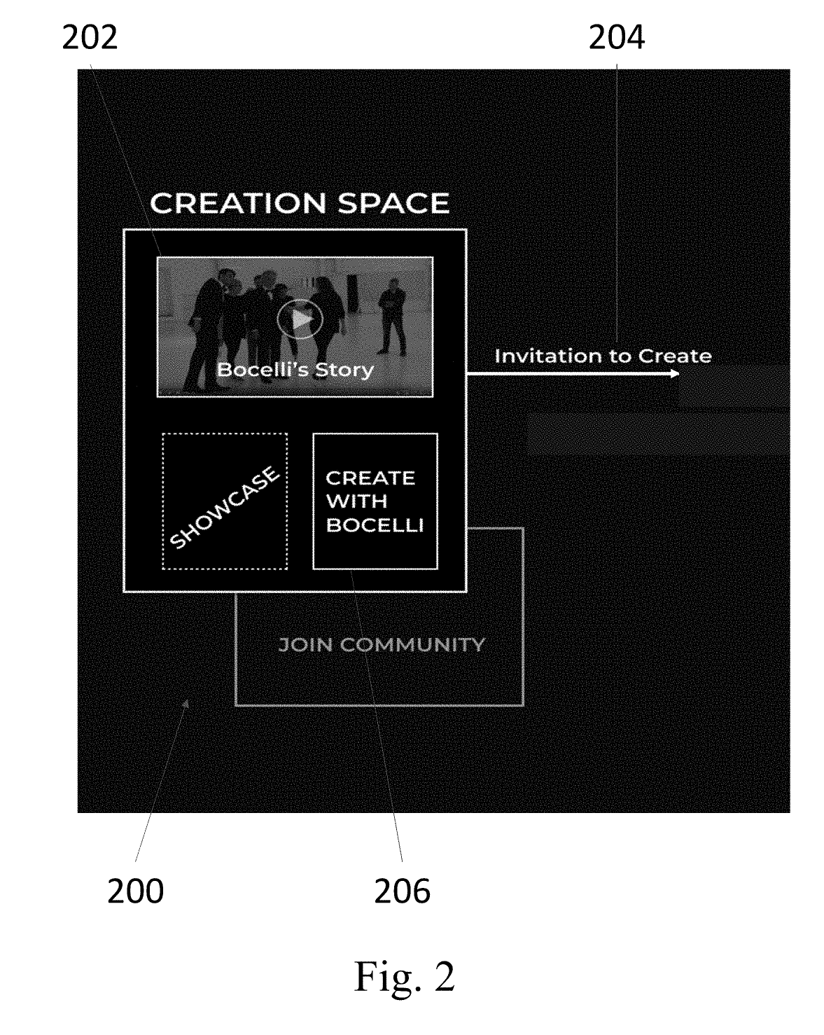

FIG. 2 depicts a diagram of an embodiment of a digital creation space 200 involved in step 102 of method 100. Digital creation space 200 may be a user interface hosted on a website, a mobile app, or some other digital space that allows an individual to access and contribute content. At medium 202, a predetermined narrative structure is provided for the individual to view, read, listen to, or otherwise consume. The predetermined narrative structure may be chosen from the above-mentioned group of story arcs. At space 206, an individual may be invited to contribute responses including narrative data to the digital creation space 200, in response to the predetermined narrative structure presented in medium 202. At connection 204, an individual's narrative data responses are compiled and delivered to the emotion engine.

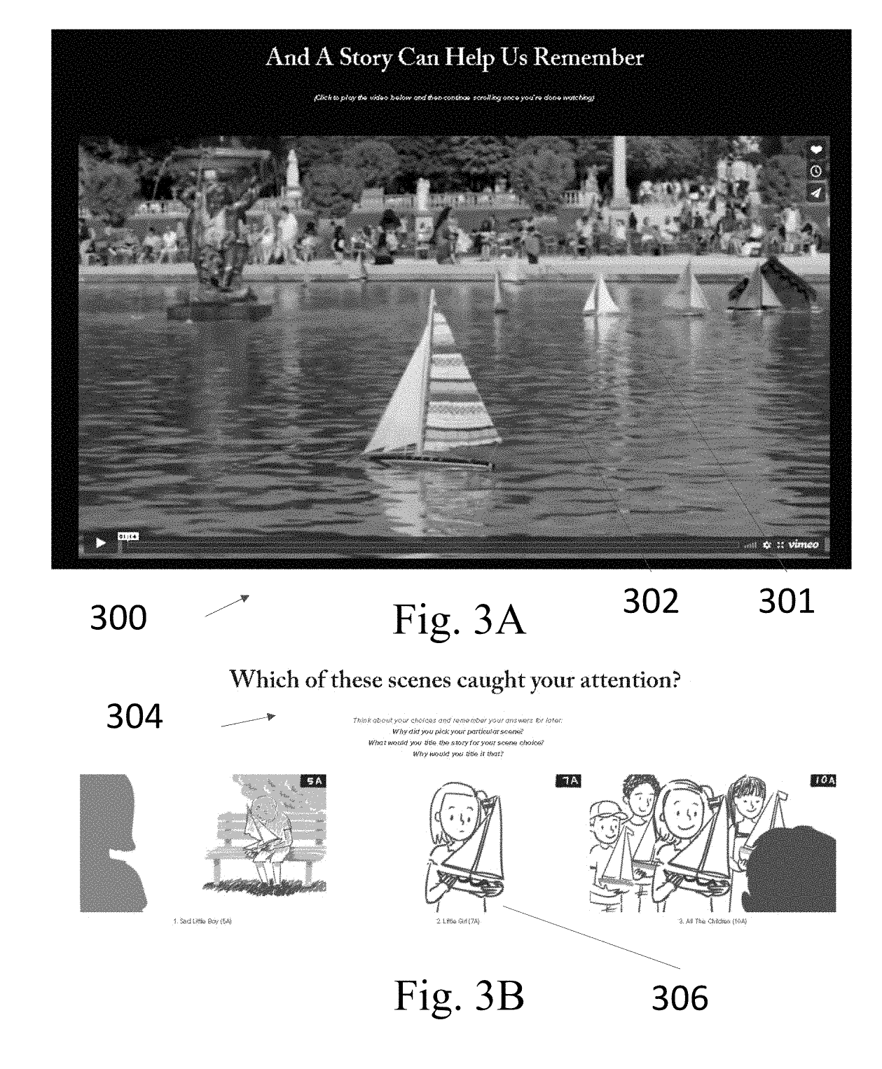

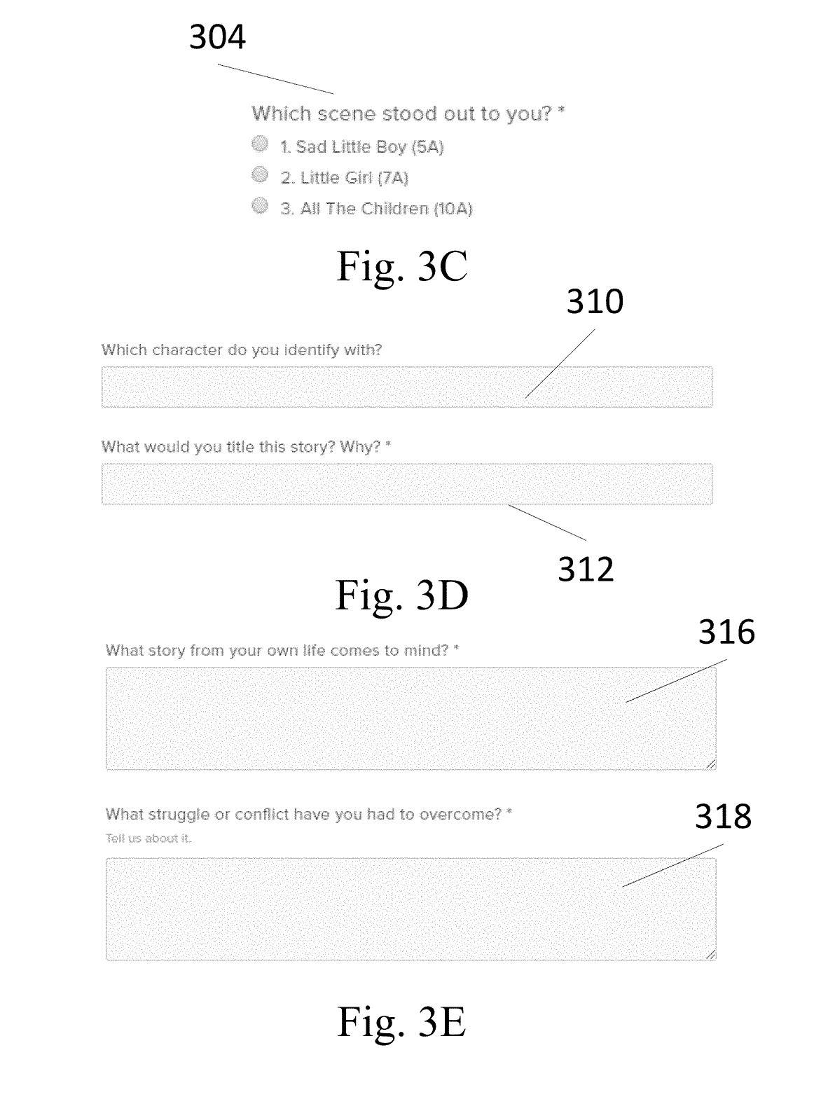

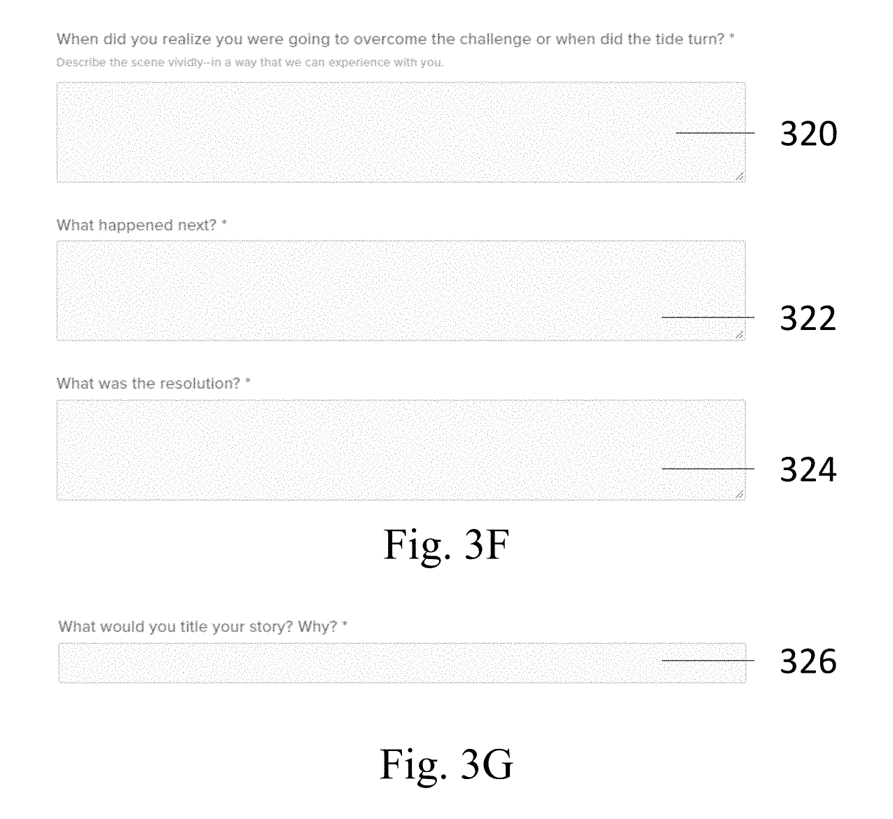

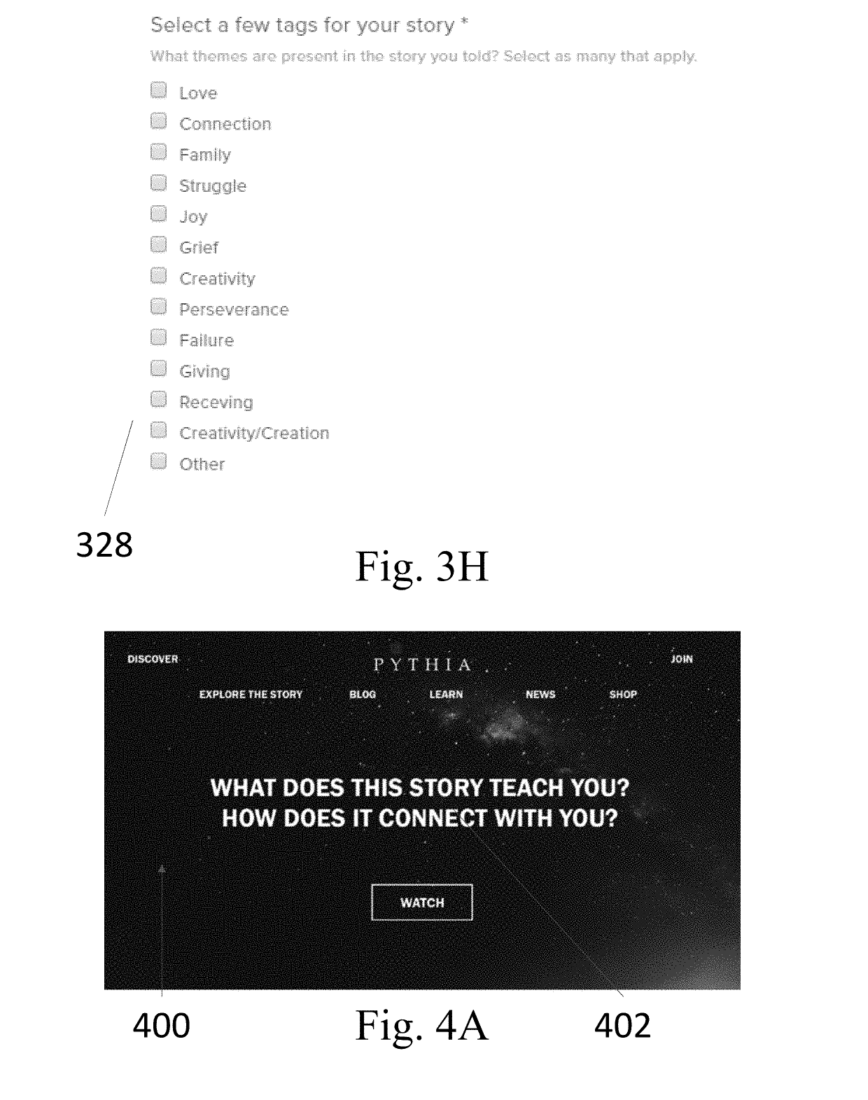

FIGS. 3A-3F depict an exemplary embodiment of a digital creation space according to the disclosure. FIG. 3A depicts a medium 300, in this embodiment a video player, presenting a predetermined narrative structure 302 for an individual to observe and consume. At FIG. 3B, a first interactive question 304 may be presented to the individual immediately following the consumption or viewing of the predetermined narrative structure 302 at medium 300. An individual may be prompted to select one of the scenes 306 that were observed in the predetermined narrative structure 302 that most caught the individual's attention or emotionally resonated with the individual. The first interactive question 304 shown in FIG. 3C may be specially arranged to re-condition an individual towards providing narrative data, such as by being gamified or reverse gamified.

Existing methods for meaningful engagement with an individual are not so selected and arranged but rather typically cause an individual to “shut down,” as the questions inartfully solicit narrative data that individuals are not conditioned to provide in a digital space or in person, and which the individuals may not feel safe enough to share in an authentic way. By contrast, the first interactive question 304 is selected to cooperate with the predetermined narrative structure to gently guide an individual through the process of parallel processing and relating personal narratives to the predetermined narrative structure without causing the individual to shut down.

As seen in FIG. 3D, additional inquiries may be presented to obtain narrative data from the individual in a stepwise progressing manner. Whereas first interactive question 304 may be a multiple-choice question that introduces a narrative question set to the individual, second interactive question 310 may by contrast ask a individual to describe what title the individual would choose for their chosen scene, thus gently urging the individual to begin thinking about and providing narrative information regarding their personal engagement with the predetermined narrative structure.

At third interactive question 312, an individual may be prompted to describe why they chose the particular title, this inquiry serving to further obtain narrative data regarding the individual's engagement, and even more importantly the reasons for the engagement, with the predetermined narrative structure. By introducing the inquiries in this manner, the individual not only provides discrete portions of a personal narrative, they are also re-conditioned and relearn how to engage with narratives in a personal narrative way.

As shown in FIG. 3E, a fourth interactive question 316 and a fifth interactive question 318 may be presented to the individual, further evoking narrative data by prompting the individual to describe a personal narrative that caused the individual to relate to the predetermined narrative structure, and which may receive particular emotional values and tags in the emotion engine that may generate an emotional profile linking the individual to other individual. Fifth interactive question 318 may elicit further narrative detail by inquiring what conflicts or struggles the individual had to overcome in the narrative pattern or life experience elicited by the predetermined narrative structure.

In embodiments, such questions as the fifth interactive question 318 may follow a predetermined narrative structure that details a rags to riches story arc, which may be advantageously chosen to elicit a rags to riches story involving a struggle or conflict that needed to be overcome in the individual's life. For example, fifth interactive question 318 may pertain to a rise act of a story arc. It will be appreciated that additional and/or different story arcs may be presented in the predetermined narrative structure, with other interactive questions presented to obtain narrative details elicited by the other story arcs.

Sixth, seventh, and eighth interactive questions 320, 322, 324 may be presented as shown in FIG. 3F, further stepping the individual through the climax, fall, and resolution acts of a story arc elicited in response to the predetermined narrative structure, and obtaining interactive narrative responses at individual input fields corresponding to the sixth, seventh, and eighth interactive questions 320, 322, 324.

A ninth interactive question 326 may be presented as shown in FIG. 3G, the ninth interactive question 326 configured to solicit a further portion of interactive narrative information by inquiring, for example, what an individual would choose to title their story or narrative response, which may assist the emotion engine of the disclosure to cross-reference the transformed information for accurate assignment of emotional values.

In FIG. 3H, a final interactive question 328 is provided in certain embodiments, allowing a individual to select themselves whichever of a predetermined slate of emotional values and tags the individual identifies or relates to in the predetermined narrative structure. As described, the individual's selected emotional values may be used to cross-reference against a cumulative emotional tag or value assigned by the emotion engine to ensure accuracy.

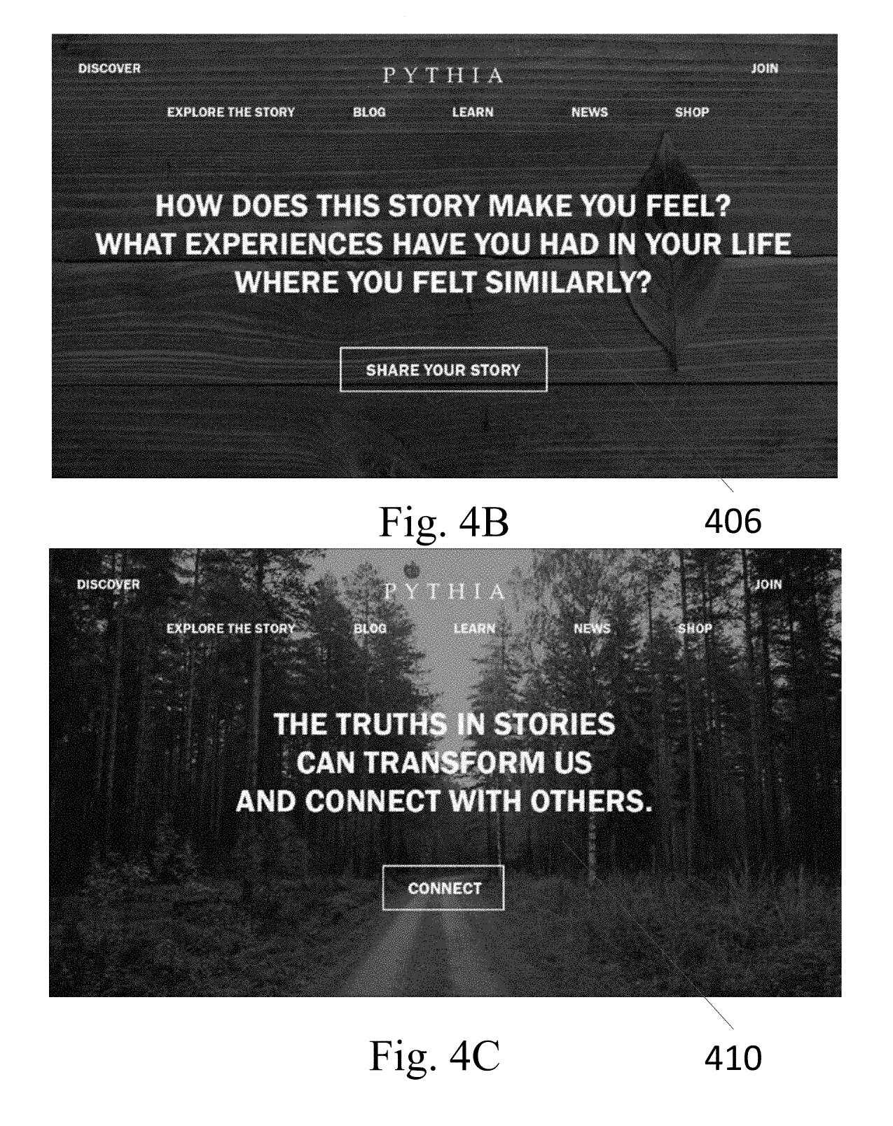

In another embodiment of the digital creation space 400 embedded in, for example, an intuitive website or mobile app, as shown in FIGS. 4A-4C, inquiries 402, 406, and 410 may be provided following a predetermined narrative structure depicted or presented in a medium (not shown), encouraging an individual to contribute narrative data in a stepwise and reverse-gamified fashion, thereby reconditioning the individual to meaningful engagement in a digital space or interpersonally, and also eliciting narrative responses that may be analyzed in the emotion engine to produce emotional profiles relating to an individual's or an audience's response to the predetermined narrative structure.

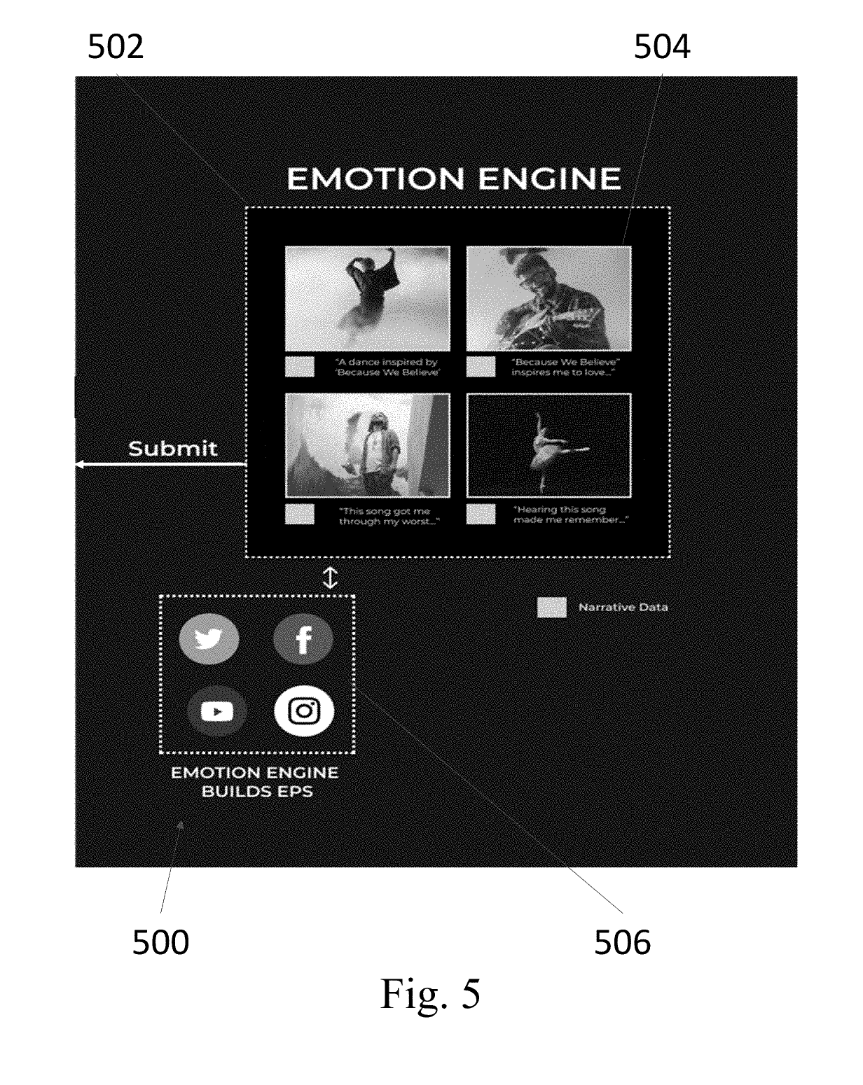

FIG. 5 depicts a diagram of the emotion engine involved in steps 104, 106, 110, and 112 of method 100. Emotion engine 500 is configured to process and store narrative data contributed by individuals in the digital creation space 200, 300 as linear narrative objects, thereby retaining the narrative context of the contributed data. In contrast to existing or conventional database systems which store data objects in discrete tables in the interest of sequeling and processing efficiency, the emotion engine 500 stores the data obtained from an individual in the narrative context and order in which it was received within a database in order to retain narrative context.

For example, narrative data 504 detailing a life experience of an individual and corresponding to the story arc of the predetermined narrative structure is received within the big data engine 502 and may be analyzed according to semantic technologies including sentiment analysis (via suitable tools such as a suitable machine learning model and/or a natural language processor). The narrative data 504 receives an emotional value from the big data engine according to objective standards (as opposed to the subjective interpretation inherent in a human interaction) at discrete points, such as at progressive inquiries that tease out one or more of the five acts of a story, within the linear narrative object.

In embodiments, the emotion engine 500 may additionally or alternatively draw upon data obtained from sources external to the digital creation space 200, 300 such as from social media sources 506. The information obtained from the social media sources 506 in the depicted embodiment are fed to and processed by the data engine 502 according to the principles described herein and in supplement to the narrative data 504 obtained in the digital creation space 200, 300. The data engine 502 assigns values to linear narrative objects and, based on its semantic analysis of the narrative data, may assign emotional values at discrete points (such as one or more of the five acts of a story) within the linear narrative objects for the purpose of developing an emotional profile, which in turn may be used to develop intertwined storylines with yet other individuals based on their narrative data. Data engine 502 may comprise a machine learning model.

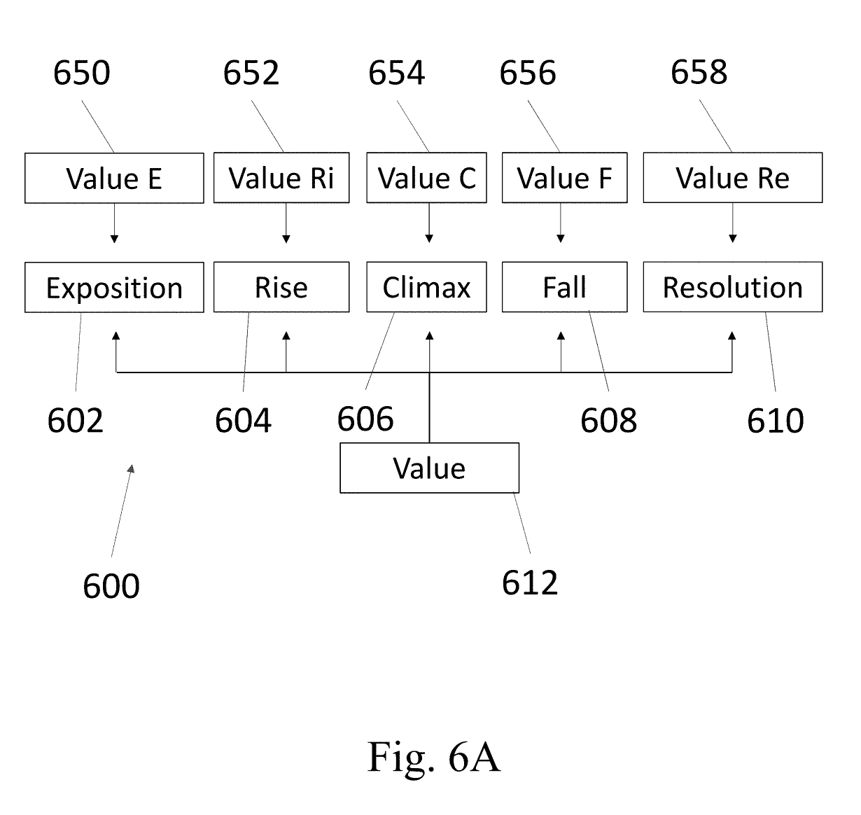

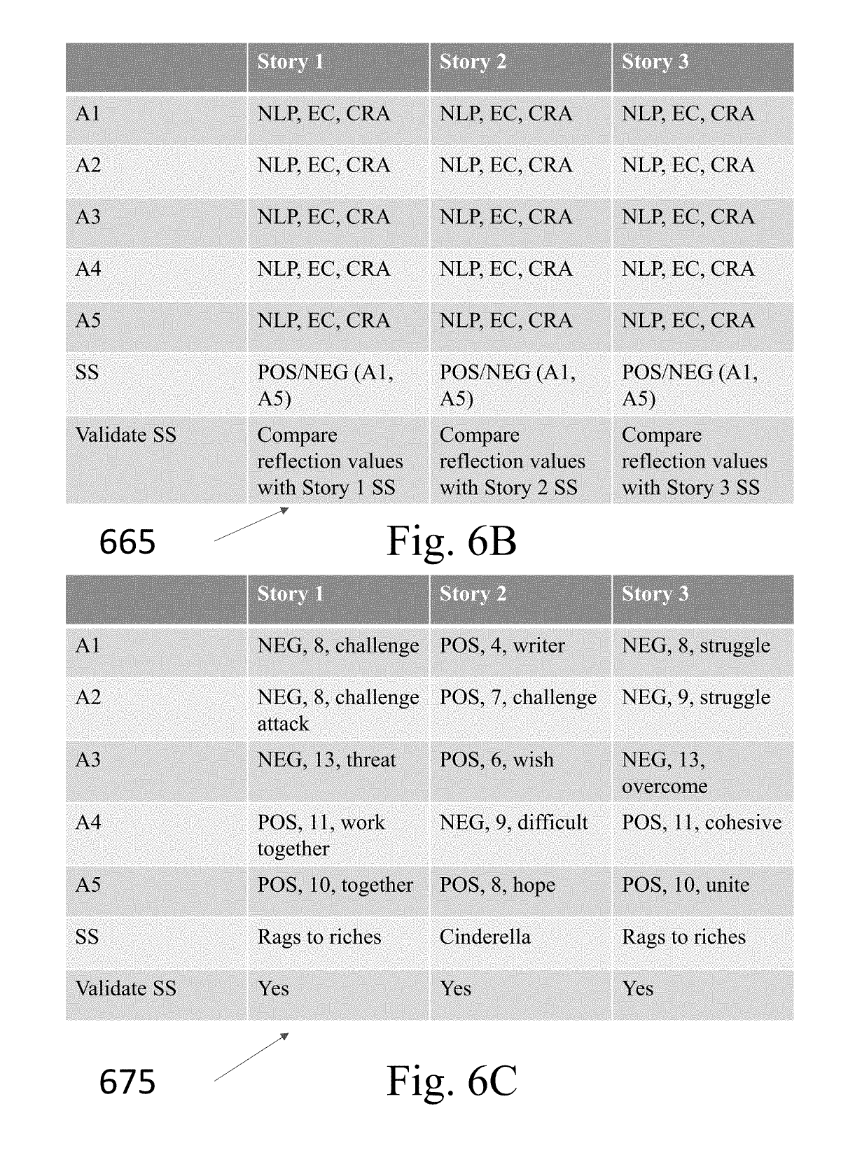

FIG. 6A depicts a diagram of obtained narrative data from the creation space 200, 300 and transformed through the emotion engine 500. Predetermined narratives and inquiries pertaining thereto obtain from an individual interactive narrative data 600 divided in discrete portions 602, 604, 606, 608, and 610, each discrete portion of data corresponding to one of the five story acts: exposition, rise, climax, fall, and resolution. The inquiries in the creation space 200, 300 may be selected to obtain data pertaining to these story acts in separate questions and in any particular order.

The emotion engine 500 may assess the content of the narrative data portions 602, 604, 606, 608, 610 through the use of sentiment analysis using natural language processing, machine learning, a combination of the foregoing, or other suitable artificial intelligence tools and according to the custom ontology. A qualitative emotional value is assigned at each of the discrete data portions, such that value 650 describes the exposition 602, value 652 describes the rise 604, and so forth. The arc of the quantitative value associated with the qualitative values 650, 652, 654, 656, 658 is used to determine a story arc associated with the narrative data 600.

Additionally, a cumulative value 612 is assessed by the emotion engine 500 for the entirety of narrative data 600, similarly using sentiment analysis as described above. The cumulative value 612 may be concatenated with the determined story arc to determine the emotional profile of the individual. For instance, the value 612 may represent abandonment and the story arc derived from values 650, 652, 654, 656, 658 may indicate a riches to rags story. Accordingly, the emotional profile of the individual may indicate that the individual resonated with an abandonment-driven riches to rags narrative. The cumulative value 612 may further be cross-referenced in embodiments against the values or tags selected by the individual regarding the individual's cumulative response.

The emotion engine 500 thus advantageously provides a combined order of rules and procedures that consistently and objectively apply a custom ontology to transform narrative text into qualitative and quantitative emotional values that are used to divine a story arc and a cumulative emotional value pertaining to an individual's narrative responses and engagement with a predetermined narrative structure.

FIGS. 6B and 6C depict a sample emotional profile outputted from the emotion engine 500. In FIG. 6B, a table 665 spans three stories: story 1, story 2, story 3, each of which may be obtained in the creation space 200, 300 from an individual, and each of which is configured to elicit five acts A1, A2, A3, A4, A5 of a story arc, the five acts A1, A2, A3, A4, A5 respectively corresponding to the aforementioned exposition, rise, climax, fall, resolution story arc. Stories 1, 2, 3 may correspond to predetermined narrative structures having different story arcs, or each of stories 1, 2, 3, may correspond to predetermined narrative structures having the same story arc, or a combination. Each of stories 1, 2, 3 is arranged adjacently, and stored in the database as a linear narrative object, with individual elements of each story corresponding to each of the five acts A1, A2, A3, A4, A5 not discretized within the database but rather stored in order.

As shown, at each of the five acts A1, A2, A3, A4, A5, three separate analyses may be performed to transform the narrative data obtained in the creation space 200, 300. In a first step, natural language processing, and more particularly semantic and/or sentiment analysis, is performed to assess the emotional valence or polarity of the act, either positive or negative. Sentiment analysis, as will be apparent to a skilled artisan, provides a system for assigning polarity to a text based on a comparison to a lexicon, a classification model continuously developed using machine learning, or a combination of the two. A natural language toolkit (NLTK) may be utilized, especially for tagging elements of the interactive narrative data as a particular part of speech (e.g. noun, proper noun, adjective, verb, article, etc.). The custom ontology may advantageously assign particular quantities or values to sentiments identified in the sentiment analysis such that a custom valence may be established and graphed, as discussed herein.

In a second step, emotion cue or detection is performed to detect which of a predetermined slate of emotions is represented in the story act. For instance, the emotion detection may associate specific words or language with a predetermined slate of emotions based on the custom ontology. In an embodiment, the emotion cue selects between 16 basic emotions, in order: amusement, anger, contempt, happiness, disgust, embarrassment, excitement, fear, guilt, pride in achievement, relief, sadness/distress, surprise, satisfaction, sensory pleasure, and shame. The predetermined slate of emotions may incorporate more or fewer emotions and a different selection of emotions than the depicted embodiment.

In a third step, centering resonance analysis (CRA) is performed to assess a centralized theme or keyword representative of the act. The centering resonance analysis, as known to a skilled artisan, may calculate the average influence of each word across the test, categorize each word based on the custom ontology, and compare and contrast each word's average influence by meaning and emotion cue.

For example, as described initially in U.S. Pat. No. 7,165,023, issued Jan. 16, 2007 and incorporated herein by reference, CRA may comprise the steps of developing a word network by parsing and tagging a narrative data object to identify noun phrases and optionally adjectives, sequentially linking the component words (nouns and adjectives) within sentences as well as co-occurrences of words within noun phrases, indexing the network of word associations to determine the influence of each word, and mapping the network or set of networks. Ultimately thematic analysis of collections may be performed. Resonance between one or more texts may further be measured based on common words or word pairs.

In other embodiments, CRA may further utilize multidimensional scaling of a set of texts, time series analysis of influences of themes, exploratory factor analysis, comparison of cluster analysis results, discounting of the preexisting cognitive similarity effect between two writers when calculating resonance, calculation of network indices, and other applications as suited to the aims of the present disclosure.

CRA may further be used to calculate a theme across a group of acts, i.e. cumulatively of an entire story. In embodiments, CRA is used to calculate the influence of a theme across all of acts A1, A2, A3, A4, A5, performing time series analysis to analyze significant correlations between the influence of themes and to ultimately provide a cumulative emotional value that may be cross-referenced against an individual-provided emotional theme for the entirety of the story and/or to be concatenated with a determined story arc.

In embodiments, network text analysis (NTA) techniques may be used to further analyze and transform the data obtained in the creation space 200, 300. NTA, as will be apparent to a skilled artisan, advantageously models a text as a network of words and the relations between them, providing important thematic insights into a text. NTA operates by selecting a particular subset or category of words, conceptualizing the selected words, determining and quantifying relationships therebetween, and extracting qualitative and quantitative meanings from the network of relationships between the selected words.

As seen in FIGS. 6A and 6B, the emotional profile 675 comprises results from the three analyses provided in the emotion engine 500. Story 1 may comprise a story structure (SS) relating to a rags to riches story arc, based on the established polarity of exposition (NEG), rise (NEG), climax (NEG), fall (POS), and resolution (POS). A rags to riches story structure based on a similar pattern of polarity is affirmed in story 3. By contrast, story 2 comprises a polarity that corresponds to a Cinderella story arc. CRA may identify emotional or narrative themes based on resonance, as indicated by certain results in story 2: writer, challenge, wish, difficult, hope.

Emotion cue analysis, such as a skilled artisan will understand to apply, for example per Ekman's basic emotions as can be identified in sentiment analysis, may indicate a particular emotion of a predetermined slate of emotions that best characterizes the individual's narrative response at a particular act as well as cumulatively of an entire narrative response. In story 1 of emotional profile 675, the identified emotions from the predetermined slate of basic emotions mentioned above are fear (8), fear (8), surprise (13), relief (11), pride in achievement (10). The emotion engine 500 may generate a final concatenation of a cumulative emotion cue or narrative theme and a story arc to characterize the individual: for instance, story 3 may be identified as an oppressed person-inspired rags to riches story.

CRA may advantageously be applied not only at a story level, i.e. to objectively assess the themes within a narrative response, but rather may also be applied at an emotional profile level, creating between the adjacent stories 1, 2, 3 an intertwined storyline of recurring or related emotional or narrative themes that links the emotional and narrative themes across multiple narratives and experiences supplied within an emotional profile.

On a third level, CRA may be applied to a community profile, intertwining storylines across multiple individuals and/or profiles. The intertwined storylines generated by applying multiple levels of CRA to thematically link different narratives and experiences generates additional narrative data and meaning than can be achieved through analysis of a single narrative. This analysis thus advantageously generates an additional dimension of analysis allowing individual responses to be collated, woven together, and transformatively interpreted to assess and respond to a heretofore unknown thematic or emotional response to a narrative structure.

It will be understood that while CRA, sentiment analysis, emotion detection, and NTA are presented as an embodiment of transformative analysis conducted, other forms of transformative analysis or artificial intelligence may be used to transform the obtained narrative information.

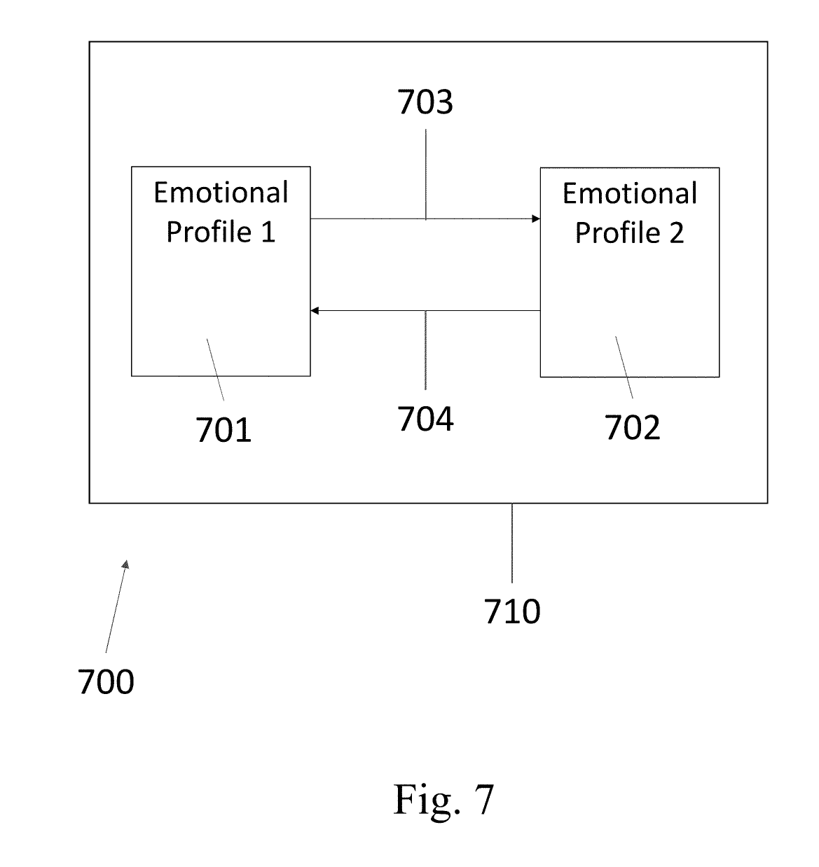

FIG. 7 shows a diagram of a listening engine 700 according to embodiments of the disclosure. A listening engine 700 advantageously combines the features of the creation space 200, 300 and the emotion engine 500 to create a system and method for obtaining and transforming interactive narrative data from multiple individuals. As emotional profiles are generated in emotion engine 500 for individuals, the emotional tags or values 650, 652, 654, 656, 658 attached to particular story acts may be intertwined with corresponding emotional tags or values at corresponding story acts in the narrative responses provided by other individuals. Community profiles 710 may be developed based on correlated data from one or more emotional profiles 701, 702.

In embodiments, the community profile 710 is built as emotional values provided by a first individual and determined in response to a particular predetermined narrative structure in emotional profile 701 are correlated at weaving procedure 703 using, for example, CRA as discussed above, to the emotional values provided by a second individual and determined in the corresponding emotional profile 702. Similarly, the values determined in emotional profile 702 are compared against and linked at weaving procedure 704 to the emotional values and narrative patterns associated in emotional profile 701.

The weaving procedures 703, 704 are arranged to find common emotional values and themes and narrative patterns between emotional profiles of different individuals. Whereas current technologies are not able to connect people in meaningful ways because they do not transform narrative data, the weaving procedures 703, 704 utilize the interactive narrative data obtained in creation space 200, 300 and transformed in emotion engine 500 to find threads of common meaning between individuals where human subjectivity and barriers to communication previously prevented meaningful connection. The weaving procedures 703, 704 may be repeated across any number of individual emotional profiles to generate larger and deeper connections between people.

For example, a person who is emotionally motivated by fear-driven rags to riches experiences in their life may be advantageously connected through system and method of the disclosure to like-minded individuals who can relate to those narrative experiences as indicated by an emotional profile developed for said like-minded individuals. A creator may interactively engage with an audience to obtain meaningful feedback on a particular creative content, benefitting from, for example, the realization that a certain percentage of their audience would benefit from a character who overcomes a family-driven Man in a hole story arc as defined and revealed in a community profile. A therapist may advantageously identify the experiences in a patient's life that have led to a particular abandonment issue by referencing the narrative recitations eliciting an abandonment emotional value in the emotion engine. Numerous other applications and benefits of the present disclosure are envisioned.

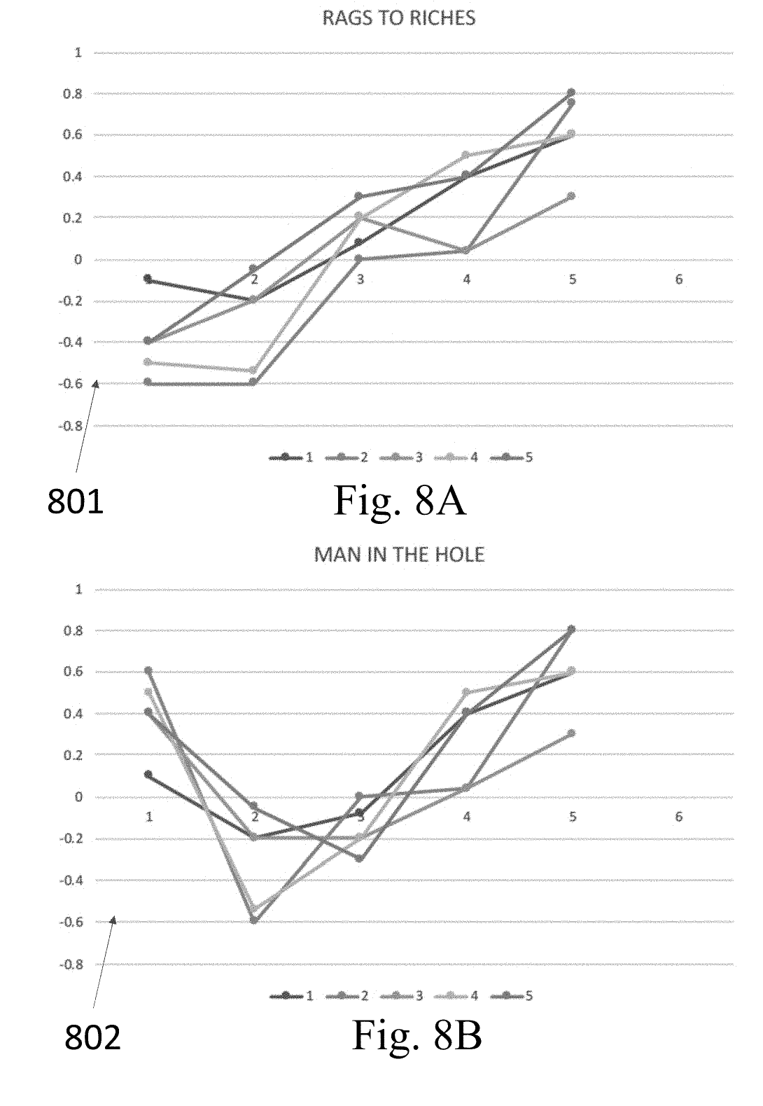

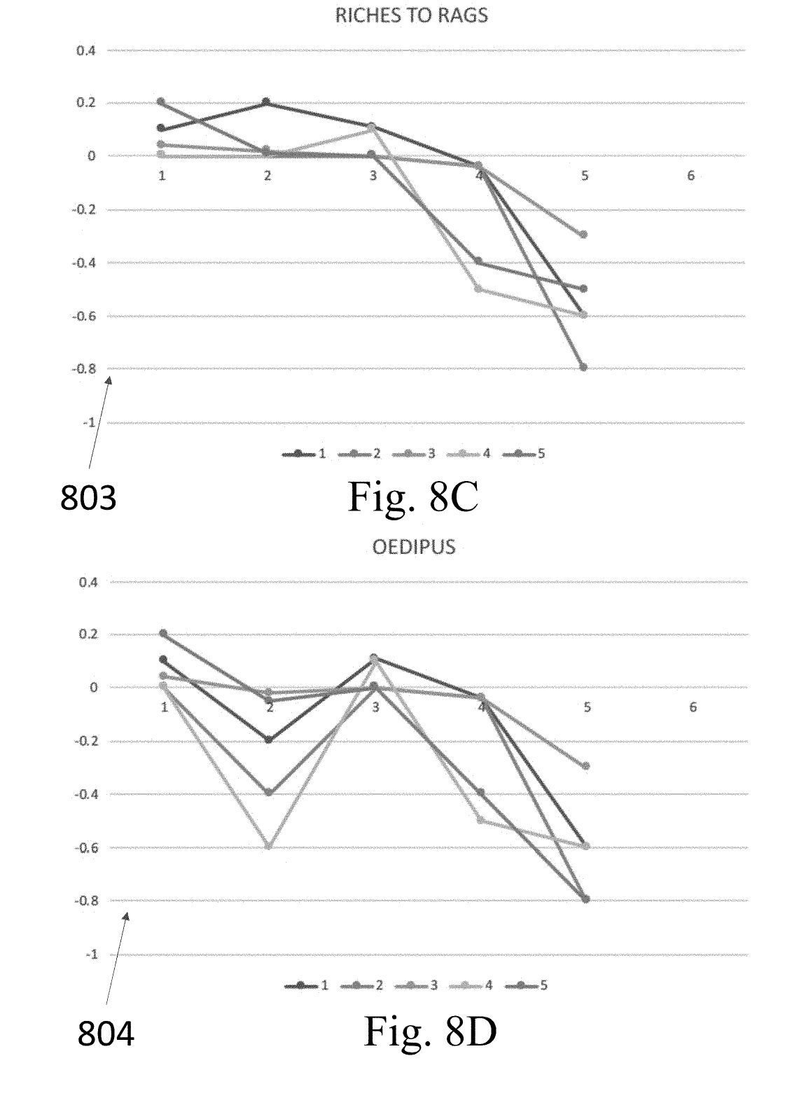

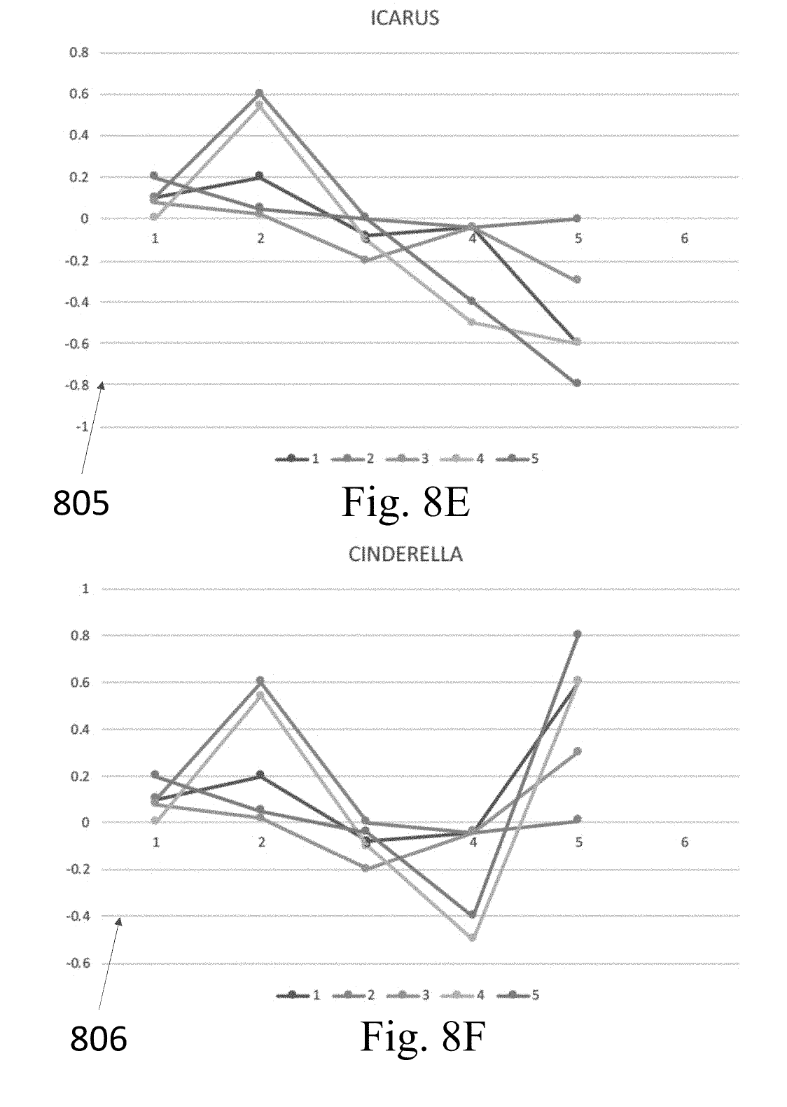

FIGS. 8A-8F depict graphical representations of story arcs identified in the emotion engine 500 and which may be displayed in the emotional profile generated therein. In FIG. 8A, a rags to riches story arc 801 is commonly identified among a plurality of narrative responses 1, 2, 3, 4, 5, shown as different colors on the graph. As seen, the narrative responses are plotted against each of the five story acts 1, 2, 3, 4, 5 corresponding respectively to exposition, rise, climax, fall, and resolution. Surprisingly, a rags to riches story arc is consistently observed among different narrative responses offered in response to predetermined narrative structures following a rags to riches story arc. This is determined by the emotional valence or polarity of each of the story acts as determined in the emotion engine 500; for instance a rags to riches story is assigned based on an exposition (−), rise (−), climax (+), fall (+), resolution (+) arc.

This happens because parallel processing causes an individual to recall a rags to riches story from their own life experience when observing a rags to riches story in the predetermined narrative structure. It will be appreciated that patterns of emotional polarity may be correlated differently in the custom ontology, such as if different populations of individuals using the creation space 200, 300 elucidate different patterns of storytelling.

An analogous effect is observed in response to each of the six story arcs previously mentioned. FIG. 8B depicts the story arc 802 identified across each of the five acts 1, 2, 3, 4, 5 of a story in different stories 1, 2, 3, 4, 5 in response to a Man in the hole predetermined narrative structure. Different stories 1, 2, 3, 4, 5, whether all from a single individual, each from different individuals, or a combination, all surprisingly correspond to the story arc of the predetermined narrative structure due to parallel processing. FIG. 8C depicts this effect at 803 in response to a riches to rags story arc, FIG. 8D depicts this effect at 804 in an Oedipus story arc, FIG. 8E depicts this effect at 805 in an Icarus story arc, and FIG. 8F depicts this effect at 806 in a Cinderella story arc. The system and method for transforming this information advantageously provides objective and quantifiable insights that yield visual representations 801, 802, 803, 804, 805, 806 of what was previously abstract, intangible memories in separate individuals.

It can be seen from FIGS. 8A-8F that by providing a sentiment analysis on each of five discrete portions of a narrative response corresponding to the five acts of a story, an individual's narrative response may yield a heretofore unobtainable and visible insight into the individual's narrative and emotional motivations as manifested in meaningful story arcs. Existing methods do not provide a system and method for obtaining such narrative information, nor do existing methods suggest a way to transform the obtained information into quantifiable, objective insights that can advantageously link individuals together based on shared experiences, emotions, and meanings.

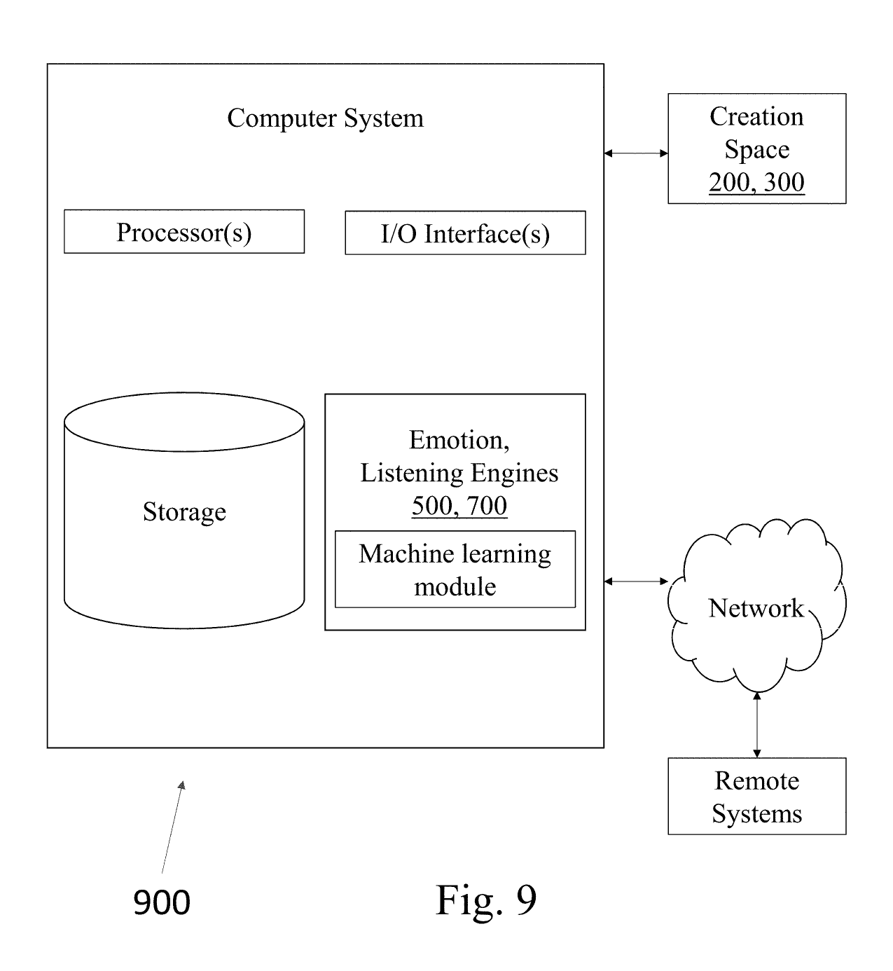

FIG. 9 depicts a computer system 900 on which the system and method for obtaining and transforming interactive narrative data may be housed and performed. The computer system may comprise storage, processor(s), I/O interfaces, and emotion and listening engines 500, 700 according to embodiments. The creation space may be in communication with the computer system 900 and may comprise input or output hardware in addition an interface through which an individual may input interactive narrative data in response to a predetermined narrative structure. Computer system 900 may be connected through a network to remote systems on which the embodiments may further be housed and performed.

Computer system 900 may be configured to communicate with an output terminal such as a display device to provide the emotional profile developed in emotion engine 500. Creation space 200, 300 may be housed on a receiving device, such that the receiving device communicates with computer system 900.

By providing a method and system for obtaining and transforming interactive narrative data, a deeper and more meaningful connection between individuals may be fostered. A digital creation space may be provided to solicit narrative data in response to a predetermined narrative structure, the narrative data being stored, processed, and transformed in advantageous and unconventional ways to provide an emotional profile that can reveal intertwined storylines in the revealing context of the predetermined narrative structure. The intertwined storylines allow for an intelligent connection between individuals, with insights provided on the meaningful life experiences driving engagement with particular elements of a narrative.

It is to be understood that not necessarily all objects or advantages may be achieved under any embodiment of the disclosure. Those skilled in the art will recognize that the system and method for obtaining and transforming interactive narrative data may be embodied or carried out in a manner that achieves or optimizes one advantage or group of advantages as taught herein without achieving other objects or advantages as taught or suggested herein.

The skilled artisan will recognize the interchangeability of various disclosed features. Besides the variations described herein, other known equivalents for each feature can be mixed and matched by one of ordinary skill in this art to build and use a system and method for obtaining and transforming interactive narrative data under principles of the present disclosure. It will be understood by the skilled artisan that the features described herein may be adapted to other methods and types of communication systems. While certain story acts and story patterns are arcs are described, said acts and arcs are exemplary are not intended to be limiting. Other acts of a story and other story patterns or arcs are envisioned.

Although this disclosure describes certain exemplary embodiments and examples of a system and method for obtaining and transforming interactive narrative data, it will be understood by those skilled in the art that the present disclosure extends beyond the specifically disclosed system and method for obtaining and transforming interactive narrative data to other alternative embodiments and/or uses of the disclosure and obvious modifications and equivalents thereof, including other types of information obtained in other types of contexts. It is intended that the present disclosure should not be limited by the disclosed embodiments described above and may be extended to other applications that may employ the features described herein.

1-3. (canceled)

4. A method for obtaining and transforming narrative data, the method comprising the steps of:
providing a digital platform configured for presenting at least one predetermined narrative to at least one individual;
obtaining narrative data in the digital platform from the at least one individual;
creating an emotional profile of the at least one individual from the obtained narrative data by:
providing a processor configured to perform semantic analysis to identify emotional variables in the obtained narrative data using a custom ontology developed and applied by the processor and comprising at least one rule defining a normalizing pattern for transforming the obtained narrative data; and
transforming the emotional predetermined variables into a concatenation of a cumulative emotional value and a narrative structure using the at least one rule of the custom ontology.

5. The method according to claim 4, wherein obtaining the narrative data comprises presenting a series of inquiries corresponding to individual story acts of a story arc of the predetermined narrative and obtaining a plurality of ordered data portions within the obtained narrative data.

6. The method according to claim 4, wherein the obtained narrative data from the at least one individual is stored in a database as a linear narrative data object undiscretized by attribute.

7. The method according to claim 4, wherein the semantic analysis utilizes a combination of at least sentiment analysis, emotion cue detection, and centering resonance analysis.

8. The method according to claim 4, wherein the semantic analysis includes sentiment analysis of the obtained narrative data, the obtained narrative data comprising a plurality of ordered data portions.

9. The method according to claim 8, wherein the sentiment analysis is performed using a natural language processing model comprising a machine learning model.

10. The method according to claim 4, wherein the emotional variables identified by the processor in the obtained narrative data comprise at least one qualitative emotional value and at least one quantitative emotional polarity assessed from the obtained narrative data.

11. The method according to claim 4, wherein the at least one rule defined by the custom ontology assigns at least a quantitative emotional polarity to each of a plurality of qualitative emotional values identified in the obtained narrative data.

12. The method according to claim 10, wherein the at least one qualitative emotional value is identified through emotion cue detection according to a predetermined set of emotional values in the custom ontology.

13. The method according to claim 10, wherein a centering resonance analysis of the semantic analysis utilizes the at least one qualitative emotional value and an average influence computed for each word contained in the obtained narrative data to yield a representative keyword for each data portion of the ordered data portions.

14. The method according to claim 12, wherein the narrative structure of the emotional profile comprises a story arc computed according to the quantitative emotional polarities assessed at subsequent data portions of the plurality of ordered data portions in the obtained narrative data.

15. The method according to claim 12, wherein the centering resonance analysis generates a representative keyword for an entirety of the obtained narrative data.

16. A computer system for obtaining and transforming narrative data, the computer system comprising:
a digital creation space comprising a platform and configured for presenting a predetermined narrative to at least one individual and obtaining at least one narrative response from the at least one individual;
a database configured for storing the obtained narrative response as a linear narrative data object; and
one or more hardware storage devices having stored thereon computer-executable instructions that are executed by a processor configured for developing a custom ontology comprising at least one rule, the processor further configured for performing semantic analysis using the custom ontology on the linear data object.

17. The computer system for obtaining and transforming narrative data according to claim 16, wherein the processor is further configured for creating an emotional profile for the at least one individual comprising at least one story arc and at least one qualitative emotional value, the emotional profile created from the linear data object.

18. The computer system for obtaining and transforming narrative data according to claim 17, wherein the processor is further configured for creating a community profile by connecting a plurality of emotional profiles.

19. The computer system for obtaining and transforming narrative data according to claim 17, wherein the processor is further configured for performing semantic analysis across a plurality of linear narrative data objects.

20. The computer system for obtaining and transforming narrative data according to claim 17, wherein the platform presents at least one inquiry to the at least one individual after presenting the predetermined narrative, the at least one inquiry eliciting a discrete narrative response and corresponding to at least one act of a story arc of the predetermined narrative.

21. The computer system for obtaining and transforming narrative data according to claim 20, wherein the processor is configured to ascertain the story arc from a plurality of qualitative emotional scores computed using semantic analysis at each discrete narrative response, the plurality of qualitative emotional scores corresponding to the story arc.

22. The computer system for obtaining and transforming narrative data according to claim 16, wherein the platform is configured for receiving a plurality of narrative responses from a single individual, the processor configured to perform a separate semantic analysis on each narrative responses of the plurality of narrative responses.

23. A method for obtaining and transforming narrative data, the method comprising the steps of:
providing a digital platform comprising a website or mobile application and configured for presenting at least one predetermined narrative to at least one individual;
obtaining narrative data in the digital platform from the at least one individual by presenting a series of inquiries corresponding to individual story acts of a story arc defined by the predetermined narrative and providing at least one data entry field configured for obtaining a plurality of ordered data points within the obtained narrative data, the series of inquiries comprising at least one inquiry prompting the individual to select at least one of a predetermined slate of qualitative emotional tags and at least one narrative inquiry requiring a narrative response from the at least one individual, the narrative response comprising narrative data;
storing the obtained narrative data in a database as a linear narrative data object undiscretized by the ordered data points; and
creating an emotional profile of the at least one individual from the obtained narrative data by:
providing a processor arranged to cooperate with a natural language processing model comprising a machine learning model, the processor configured to perform semantic analysis to identify emotional variables including at least one qualitative emotional value and at least one quantitative emotional polarity in the linear narrative data object using a custom ontology developed and applied by the processor, the custom ontology comprising at least one rule defining a normalizing pattern for transforming the obtained narrative data, the at least one rule assigning at least a quantitative emotional polarity to each of a plurality of qualitative emotional values;
the semantic analysis comprises using a combination of at least sentiment analysis, emotion cue detection, and centering resonance analysis, the emotion cue detection yielding the at least one qualitative emotional value according to a predetermined set of emotional values in the custom ontology, the centering resonance analysis utilizes the at least one qualitative emotional value and an average influence computed for each word contained in the linear narrative data object to yield a representative keyword for each data portion of the ordered data portions and for an entirety of the linear narrative data object; and
transforming the emotional predetermined variables into a concatenation of a cumulative emotional value and a narrative structure using the at least one rule of the custom ontology, the narrative structure comprising a story arc computed according to the quantitative emotional polarities assessed at subsequent data portions of the plurality of ordered data portions in the linear narrative data object.
